(19) United States
(12) Patent Application Publication
(10) Pub. No.: US 2006/0070011 A1
(43) Pub. Date: Mar. 30, 2006

(54) Display control device, image forming apparatus and display control method

(75) Inventors: Kenji Matsuhara, Kawanishi-shi (JP); Daisetsu Tohyama, Amagasaki-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Konica Minolta Business Technologies, Inc., Tokyo (JP)

(21) Appl. No.: 11/237,905

(22) Filed: Sep. 29, 2005

(30) Foreign Application Priority Data
Sep. 29, 2004 (JP) 2004-284779

(51) Int. Cl. G06F 17/00; G06F 12/14

(52) U.S. Cl. 715/816; 726/16

(57) ABSTRACT

A display control device comprises: an extractor for extracting candidates of a character sequence to be retrieved when at least a part of the character sequence to be retrieved is input; a display controller for displaying, on a display, the candidates of the character sequence to be retrieved extracted by the extractor; and a setter capable of setting display allowance according to the character sequence to be retrieved. Here, the display controller excludes the character sequence to be retrieved, which has been set not to be displayed by the setter, from information to be displayed.

This application claims priority under 35 U.S.C. § 119 to Japanese Patent Application No. P2004-284779 filed on Sep. 29, 2004, the entire disclosure of which is incorporated herein by reference in its entirety.

### BACKGROUND OF THE INVENTION

1. Field of the Invention

The present invention relates to a display control device for use in an image forming apparatus in, for example, an MFP (abbreviating a multi function peripheral) or a computer, an image forming apparatus provided with the display control device and a display control method.

2. Description of the Related Art

The following description sets forth the inventor's knowledge of related art and problems therein and should not be construed as an admission of knowledge in the prior art.

In recent years, there has been adopted a method for authenticating and specifying a user by inputting a user name and a password in order to ensure the security of an image or a document or manage resources such as a toner or a sheet in using an image forming apparatus in, for example, an MFP for processing various images or documents.

In such an MFP, an administrator can perform administration with ease on the introduction of user authentication: in turn, a user suffers cumbersomeness since he or she must input his or her user name and password every usage.

In order to solve the above-described problem, Japanese Unexamined Patent Publication No. 2002-197439 discloses the technique in which upon inputting of at least one character (including a numeral) on a user authentication screen, candidates of user names starting from that character are listed on a display.

Additionally, Japanese Unexamined Patent Publication No. 2003-196314 discloses the technique in which a field to be retrieved is designated, retrieval characters are input one by one in each field, and candidates matching with the beginning of the characters are extracted and displayed in accordance with the input.

In the prior art disclosed in the above-described gazettes, upon inputting of at least one character of a user name or the like on the user authentication screen, the candidates of the user names have been listed, thereby simplifying an input operation. To the contrary, personal information on a user who uses the MFP or the like also has been displayed on the list of the user names.

As a consequence, although there has not been any trouble in the case where the user himself or herself operates the MFP or the like, he or she has requested that his or her name should be never displayed as the user name when other users operate the MFP or the like. However, there has arisen a problem that the request cannot be met in the above-described prior art.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The preferred embodiments of the present invention can significantly improve upon existing methods and/or apparatuses.

Among other potential advantages, some embodiments can provide a display control device and display control method capable of excluding user information from information to be displayed at the request of a user in the case where candidates of user names or the like are displayed on a display upon inputting of at least a part of a user name or the like.

Among other potential advantages, some embodiments can provide an image forming apparatus provided with the display control device.

According to a first aspect of a preferred embodiment of the present invention, a display control device, comprises:

an extractor for extracting candidates of a character sequence to be retrieved when at least a part of the character sequence to be retrieved is input;

a display controller for displaying, on a display, the candidates of the character sequence to be retrieved extracted by the extractor; and

a setter capable of setting display allowance according to the character sequence to be retrieved;

wherein the display controller excluding the character sequence to be retrieved, which has been set not to be displayed by the setter, from information to be displayed.

According to a second aspect of a preferred embodiment of the present invention, a display control device comprises:

an extractor for extracting candidates of user names when at least a part of a user name is input in order to get authentication in using an image forming apparatus;

a display controller for displaying, on a display, the candidates of the user names extracted by the extractor; and

a setter capable of setting display allowance according to the user name;

wherein the display controller excluding the user name, which has been set not to be displayed by the setter, from information to be displayed.

According to a third aspect of a preferred embodiment of the present invention, a display control device comprises:

a setter capable of setting display allowance according to a user name when a predetermined user name is selected from user names displayed on a display, and then, the function of an image forming apparatus is used; and

a display controller for controlling as to whether or not each of the user names is displayed on the display based on contents set by the setter.

According to a fourth aspect of a preferred embodiment of the present invention, an image forming apparatus comprises:

an extractor for extracting candidates of a character sequence to be retrieved when at least a part of the character sequence to be retrieved is input;

a display controller for displaying, on a display, the candidates of the character sequence to be retrieved extracted by the extractor; and

a setter capable of setting display allowance according to the character sequence to be retrieved;

wherein the display controller excluding the character sequence to be retrieved, which has been set not to be displayed by the setter, from information to be displayed.

According to a fifth aspect of a preferred embodiment of the present invention, an image forming apparatus comprises:

an extractor for extracting candidates of user names when at least a part of a user name is input in order to get authentication in using an image forming apparatus;

a display controller for displaying, on a display, the candidates of the user names extracted by the extractor; and

a setter capable of setting display allowance according to the user name;

wherein the display controller excluding the user name, which has been set not to be displayed by the setter, from information to be displayed.

According to a sixth aspect of a preferred embodiment of the present invention, an image forming apparatus comprises:

a setter capable of setting display allowance according to a user name when a predetermined user name is selected from user names displayed on a display, and then, the function of an image forming apparatus is used; and

a display controller for controlling as to whether or not each of the user names is displayed on the display based on contents set by the setter.

According to a seventh aspect of a preferred embodiment of the present invention, a display control method comprises the steps of:

extracting candidates of a character sequence to be retrieved when at least a part of the character sequence to be retrieved is input;

controllably displaying, on a display, the candidates of the character sequence to be retrieved extracted in the extracting step; and

setting display allowance according to the character sequence to be retrieved;

wherein the character sequence to be retrieved, which has been set not to be displayed in the display allowance setting step, being excluded from information to be displayed in the controllably displaying step.

According to an eighth aspect of a preferred embodiment of the present invention, a display control method comprises the steps of:

extracting candidates of user names when at least a part of a user name is input in order to get authentication in using an image forming apparatus;

controllably displaying, on a display, the candidates of the user names extracted in the extracting step; and

setting display allowance according to the user name;

wherein the user name, which has been set not to be displayed in the display allowance setting step, being excluded from information to be displayed in the controllably displaying step.

According to a ninth aspect of a preferred embodiment of the present invention, a display control method comprises the steps of:

setting display allowance according to a user name when a predetermined user name is selected from user names displayed on a display, and then, the function of an image forming apparatus is used; and

controlling as to whether or not each of the user names is displayed on the display based on contents set in the display allowance setting step.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a block diagram illustrating an image forming system by the use of an image forming apparatus (e.g., an MFP) provided with a display control device in a preferred embodiment according to the invention;

FIG. 2 is a block diagram illustrating the electric arrangement of the MFP used in FIG. 1;

FIG. 3 is a block diagram illustrating respective functions of the MFP and a user terminal used in FIG. 1;

FIG. 4 is a diagram illustrating a standby screen at the time of user authentication;

FIG. 5 is a diagram illustrating an input screen at the time of the user authentication;

FIG. 6 is a diagram illustrating a screen, on which registration keys of user names are listed in a state in which initial two characters are input;

FIG. 7 is a diagram illustrating a screen, on which a registration key of a predetermined user name is not displayed in the state in which the initial two characters are input;

FIG. 8 is a diagram illustrating a screen, on which registration keys of user names are listed in a state in which initial four characters are input;

FIG. 9 is a diagram illustrating a screen, on which a registration key of a predetermined user name is not displayed in the state in which the initial four characters are input;

FIG. 10 is a diagram illustrating a destination selection screen, on which registration keys of user names are listed, in a scan mode;

FIG. 11 is a diagram illustrating a destination selection screen, on which a registration key of a predetermined user name is not displayed, in the scan mode;

FIG. 12 is a diagram illustrating a storage destination selection screen, on which registration keys of user names are listed, in a box storage mode;

FIG. 13 is a diagram illustrating a storage destination selection screen, on which a registration key of a predetermined user name is not displayed, in the box storage mode;

FIG. 14 is a diagram illustrating a storage destination selection screen, on which a registration key of a predetermined user name different from that set in the scan mode is not displayed, in the box storage mode;

FIG. 15 is a flowchart illustrating a processing routine executed by a CPU 8 in the MFP 1 in inputting the user name at the time of the user authentication;

FIG. 16 is a flowchart illustrating a sub-routine of a user name listing processing illustrated in FIG. 15;

FIG. 17 is a flowchart illustrating a sub-routine of a reading processing of display allowance setting when the registration keys of the user names are displayed during the use of the function of the MFP 1;

FIG. 18 is a flowchart illustrating a sub-routine of processing of user name display allowance setting illustrated in FIG. 15;

FIG. 19 is a flowchart following the flowchart illustrated in FIG. 18;

FIG. 20 is a diagram illustrating a user name display allowance setting screen; and

FIG. 21 is a diagram illustrating a user name display allowance individually setting screen.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

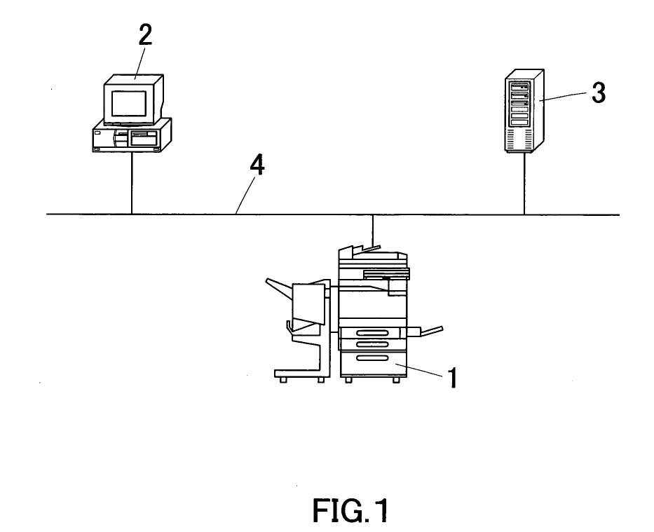

FIG. 1 is a block diagram illustrating an image forming system by the use of an image forming apparatus provided with a display control device in a preferred embodiment according to the invention.

An image forming system illustrated in FIG. 1 comprises an MFP 1 serving as an image forming apparatus, a user terminal 2 including a personal computer and the like and an authentication server 3 installed outside of the MFP 1. The MFP 1, the user terminal 2 and the authentication server 3 are connected to each other via a network 4.

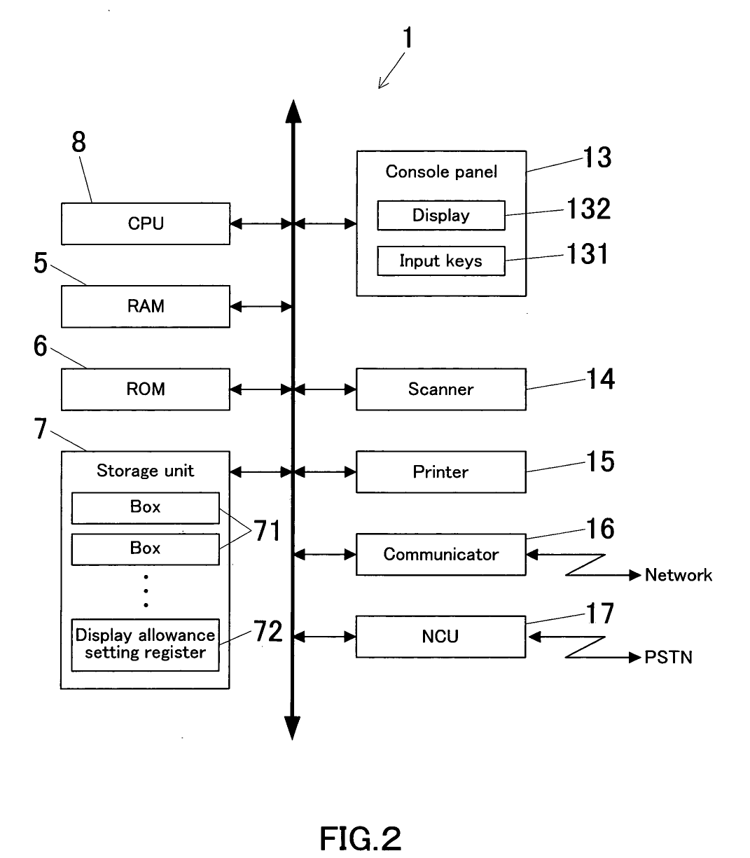

FIG. 2 is a block diagram illustrating the electric arrangement of the MFP 1.

The MFP 1 can scan, copy, print and fax image data. In FIG. 2, the MFP 1 includes a CPU 8, a RAM 5 serving as a work region of a program executed by the CPU 8, a ROM 6 storing an operational program of the CPU 8 therein, a storage unit 7, an operation panel 13, a scanner 14, a printer 15, a communicator 16 and an NCU (abbreviating “a network control unit”) 17.

The storage unit 7 not only stores therein various programs and image data scanned by the scanner 14 but also stores a user registration name, that is, a user name and setting information on whether or not the user name is allowed to be listed on a display on the user terminal or a display on the operation panel 13 in a display allowance setting register 72. Furthermore, the storage unit 7 includes a plurality of boxes 71 . . . consisting of nonvolatile storage regions, in which various files including the image data and the like are stored. These boxes are designed to be managed by users, respectively.

The operation panel 13 includes various input keys 131 such as a mode setting key, a start button and ten keys, and a display 132 of a touch panel type made of a liquid crystal, which are operated at the time of the use of the MFP 1 or mode setting.

The scanner 14 is adapted to scan an image of a document, and then, to convert it into image data.

The printer (also referred to as “a print unit”) 15 is designed to print, on a sheet, the image data scanned by the scanner 14, the image data stored in the box 71 of the storage unit 7 and the like.

The communicator 16 functions as a network interface for transmitting and receiving various kinds of data such as the image data between the user terminal 2 and the MFP 1 via the network 4.

The NCU 17 is adapted to control transmission to and reception from a party on the other end, connected via a normal telephone line, and is used at the time of facsimile (hereinafter also abbreviated as “a FAX”) transmission and reception.

The CPU 8 comprehensively controls the entire MFP 1, and additionally, has various kinds of functions in the present preferred embodiment. Specifically, the CPU 8 has the function of extracting corresponding candidates from the user names stored in the storage unit 7 when a part of the user name, for example, is input as a character sequence to be retrieved. In addition, the CPU 8 also has the function of listing the extracted candidates of the user names on the display 132 on the operation panel 13 or the display on the user terminal 2.

Moreover, the CPU 8 also has the function of setting and registering as to whether or not each of the user names stored in the storage unit 7 is displayed on the display 132 on the operation panel 13 or the display on the user terminal in the display allowance setting register 72 based on an instruction input by a user. Based on the set and registered contents, the CPU 8 controls as to whether or not the user name is excluded from the user names to be displayed.

Furthermore, in the above-described setting, the CPU 8 also has the function of judging as to whether or not the user name to be set is identical to a user name of a user which is authenticated by the authentication server 3, and then, allowing the setting only if it is identical, in other words, only in the case where a user authenticated by the authentication server 3 sets the display allowance of his or her own user name.

Additionally, the CPU 8 also has the function of judging as to whether the user accesses the MFP 1 from the user terminal 2 (i.e., a network access) or from the operation panel 13 in the MFP 1 per se (i.e., a unit access), and further, has the function of displaying a display screen for re-setting the display allowance of a user name on the display on the user terminal 2 or the display 132 on the operation panel 13 when the user logs off the MFP 1.

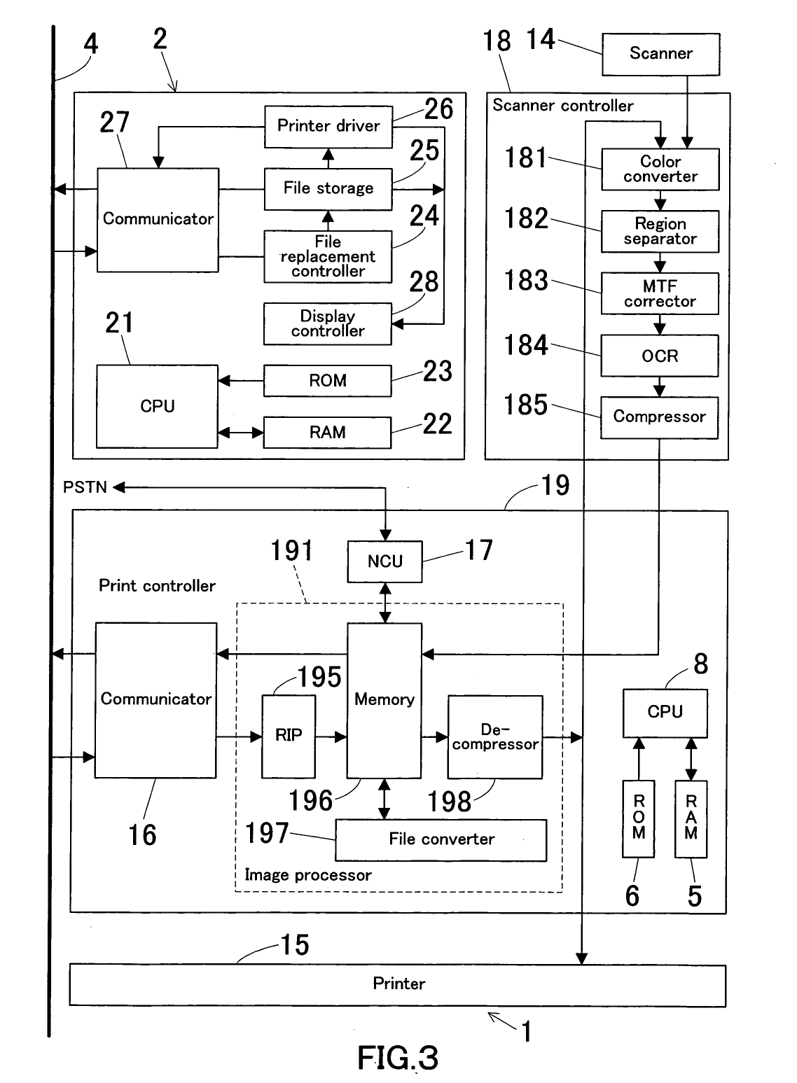

FIG. 3 is a block diagram illustrating the functions of each of the MFP and the user terminal 2.

In FIG. 3, the MFP 1 includes a scanner controller 18 with respect to the scanner 14 and a print controller 19 with respect to the printer 15. In the meantime, the user terminal 2 includes a file replacement controller 24, a file storage 25, a printer driver 26, a communicator 27 for transmitting or receiving data to or from the MFP 1 or the like via the network 3 and a display controller 28 in addition to a CPU 21, a RAM 22 and a ROM 23.

The scanner controller 18 in the MFP 1 is constituted of a color converter 181, a region separator 182, an MTF corrector 183, an OCR 184, a compressor 185 and the like.

The print controller 19 includes an image processor 191 and the like in addition to the CPU 8, the RAM 5, the ROM 6, the communicator 16 and the NCU 17.

The image processor 191 consists of an RIP (abbreviating “a raster image processor”) 195, a memory 196, a file converter 197, a de-compressor 198 and the like.

The authentication server 3 authenticates a user based on user information transmitted from the MFP 1 and user information stored in the authentication server 3, and then, it transmits the result from the authentication server 3 to the MFP 1.

In using the MFP 1, the user accesses the MFP 1, and then, he or she need be authenticated by inputting a user ID, a password and the like. As described above, access methods to the MFP 1 include the unit access from the operation panel 13 in the MFP 1 and the network access from the user terminal 2 via the network 4.

In the case of the unit access, the user logs in the MFP 1 from the operation panel 13, and then, inputs the user ID, the password and the like from the operation panel 13. In contrast, in the case of the network access, the user inputs the user ID, the password and the like by using a display screen on the display and an input operating tool such as a keyboard or a mouse in the user terminal 2.

Explanation will be made below on an example of the unit access.

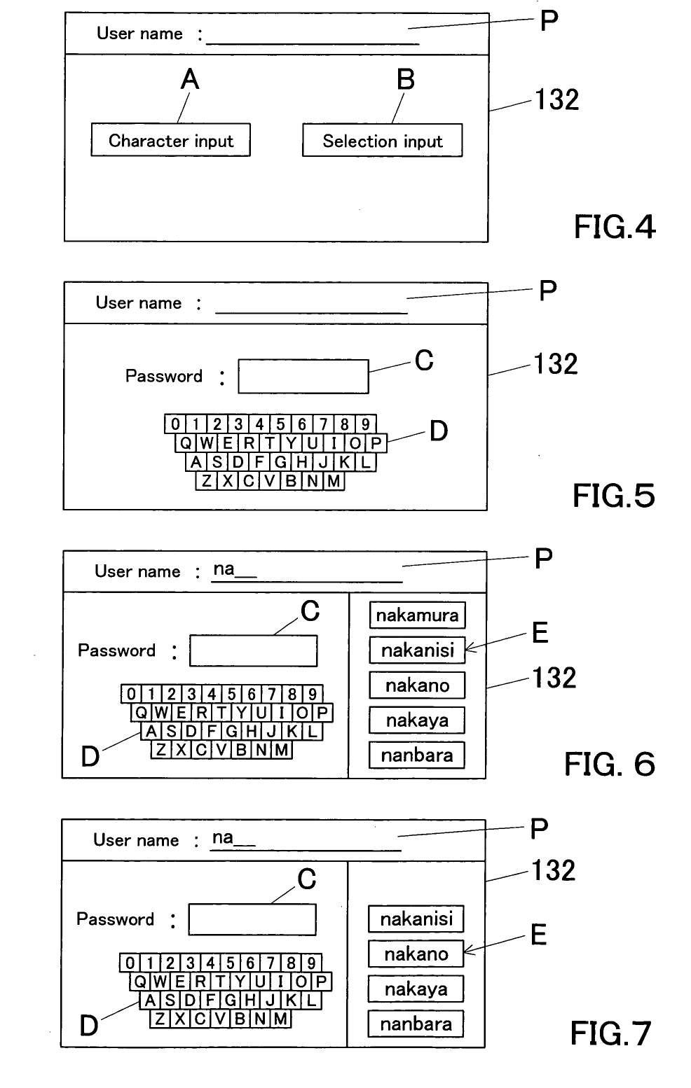

FIG. 4 illustrates an authentication screen for user authentication displayed on the display 132 on the operation panel 13 in the MFP 1. On the screen illustrated in FIG. 4 are displayed a “character input” key A for inputting all characters and a “selection input” key B for selectively inputting a user name on a list while specifying corresponding candidates of the user names every time one character of the user name is input together with a user name input line R

When the user selectively operates the “selection input” key B, the screen on the display 132 on the operation panel 13 is switched to a display screen illustrated in FIG. 5. On this screen are displayed the user name input line P, a password input line C and an input key D consisting of alphabets. The user inputs the user name and the password by the input key D.

In order to readily input the user name, as soon as the user inputs initial characters of the user name on this screen, user registration keys E indicating the user names are listed, as illustrated in FIG. 6.

In an example illustrated in FIG. 6, in the case where a user inputs his or her user name “nakamura” all of the registration keys E indicating the user names starting from “na” (i.e., “nakamura”, “nakanisi”, “nakano”, “nakaya” and “nanbara”) are displayed upon first inputting “na”. Also when another user (having a user name, for example, “nakanisi”) inputs “na” during usage, all of the user names including the user name “nakamura” are listed.

If the user (having the user name “nakamura” in this example) intends not to list the registration key indicating his or her user name on a user authentication screen when other users use, he or she previously sets in such a manner as not to display the registration key (hereinafter also referred to as “display-off”). Specifically, the user sets the display-off of the registration key E indicating his or her user name “nakamura” when the other users operate, as illustrated in FIG. 7. This setting will be described later.

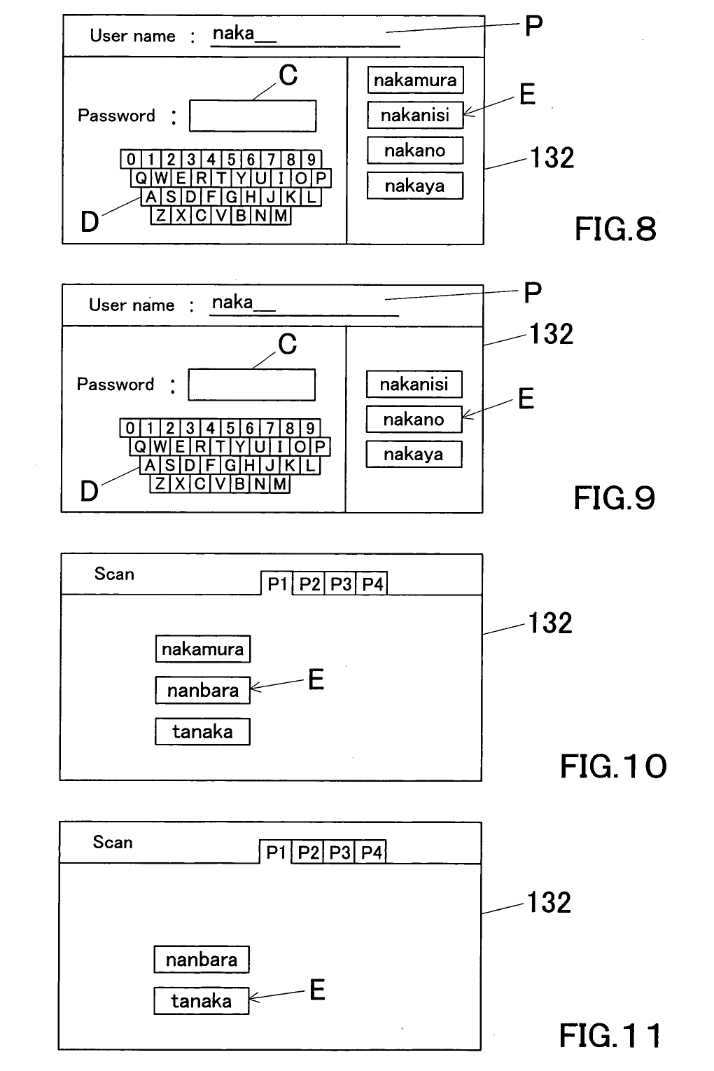

FIG. 8 illustrates a screen when “naka” is input in a state in which the display-off is not set. At this time, the user name “nanbara” not having “naka” is excluded from the list, so that the candidates of the user names are further specified. FIG. 9 illustrates a screen when “naka” is input in a state in which the display-off is set. At this time, the user name “nakamura” also is excluded from the list in addition to the user name “nanbara”.

In this manner, the user can prevent his or her personal information from being known to the other users since his or her user name is not displayed when the other users select the “selection input” key B if the user previously sets the display-off of his or her user name. Otherwise, if the user selectively operates the registration key E indicating his or her user name in a state in which the candidates of the user names are appropriately specified since the user names whose display-off is not set are listed, the user name is reflected on the user name input line R As a consequence, the user need not input all of the characters of the user name, thereby simplifying the input operation.

In this manner, after the user inputs his or her user name, the user inputs his or her password by the use of the input key D, and then, depresses an Enter key, not illustrated. And then, the information is received in the MFP 1, in which the CPU 8 transmits the information to the authentication server 3. Thereafter, when authentication is established by the authentication server 3, the user can use the MFP 1.

The preferred embodiment illustrated in FIGS. 4 to 9 has exemplified the case of the display-off of the user name when the user name is input for the purpose of the authentication. However, the setting of the user name display allowance is applicable to not only the authentication but also all of cases where the functions of the MFP 1 are used by selectively operating a predetermined user name from the list of the user names.

For example, on a scan mode on which the image data scanned by the scanner 14 or the image data stored inside of the boxes 71 . . . is designated, to be then transmitted to a destination by an e-mail or an FTP (abbreviating a file transfer protocol), the setting of the user name display allowance is applicable also to the case where the destination is designated by selecting the user name from the list of the user names. This case is illustrated in FIGS. 10 and 11.

That is to say, in the case where the image data is transmitted by designating the destination, all of the registration keys E (i.e., “nakamura”, “nanbara” and “tanaka”) are displayed, as illustrated in FIG. 10, and then, a required destination is selected from the list. Also in this case, if the user intends not to display the registration key E indicating his or her user name (e.g., “nakamura”), the user name “nakamura” cannot be displayed by previously setting the display-off, as illustrated in FIG. 11.

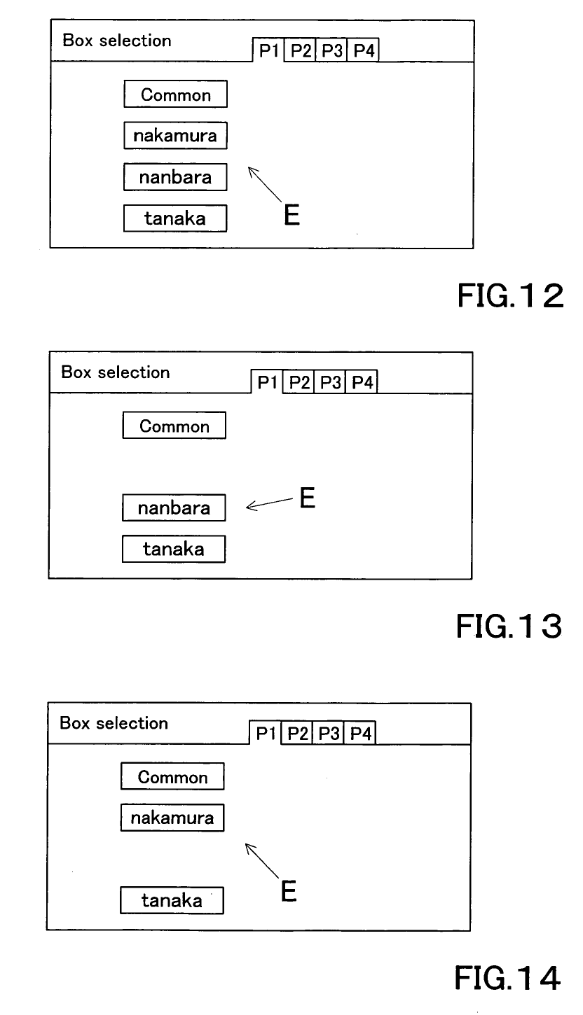

In the meantime, FIGS. 12 and 13 illustrate the case where a storage box is designated by selecting the user name from the list of the user names on a box storage mode on which the image data scanned by the scanner 14 or print data transmitted from the user terminal 2 is stored in the boxes 71.

That is to say, in the case where the image data is stored by designating the storage box, all of the registration keys E (i.e., “common”, “nakamura”, “nanbara” and “tanaka”) are displayed, as illustrated in FIG. 12, and then, a box for a required user name is selected from the list. Also in this case, if the user intends not to display the registration key E indicating his or her user name (e.g., “nakamura”), the user name “nakamura” cannot be displayed by previously setting the display-off, as illustrated in FIG. 13.

Although a detailed description will be omitted below, in the case where the image data is transmitted to a designated transmission destination on a facsimile transmission mode, the setting is also applicable to the selection of a transmission destination from the list of the user names.

Furthermore, like in the case where the transmission destination of the image data or the like is selected by the user name and in the case where the destination of the storage box of the image data or the like is selected by the user name, the display allowance setting contents may be varied according to the function used.

For example, the display-off of the user name “nakamura” may be set in the case of the selection of the transmission destination, as illustrated in FIG. 11: in contrast, the display-off of the user name “nakamura” may not be set but the display-off of the user name “nanbara” may be set in the case of the selection of the destination of the storage box, as illustrated in FIG. 14. In this manner, it is possible to eliminate any trouble that a user's PC or a mail server is adversely influenced by setting a publicly opened user name of a transmission destination as a network transmission destination of unnecessary data transmitted from malevolent users. Alternatively, since a region on a hard disk of the MFP 1 is merely occupied even in the above-described case of the selection of the destination of the storage box, the display-on or the display-off can be properly set in the balance between the convenience for the user and leakage of personal information according to the usage condition of the MFP or usage ambient of the MFP 1 for the user, for example, display-on is set in important consideration of convenience.

Otherwise, the setting of the user name display allowance may be changed according to the unit access or the network access even with respect to the same function. For example, in the case of the selection of the destination of the storage box, the display-off is not set at the time of the unit access: in contrast, the display-off is set at the time of the network access. The above-described setting can eliminate a fear that the user name is known to many users, although an indefinite number of users may possibly access at the time of the network access.

In this way, it is possible to flexibly cope with a demand of the user by varying the setting according to the function to be used or by varying the setting according to the unit access or the network access, thus providing the apparatus with ease of use according to the realities.

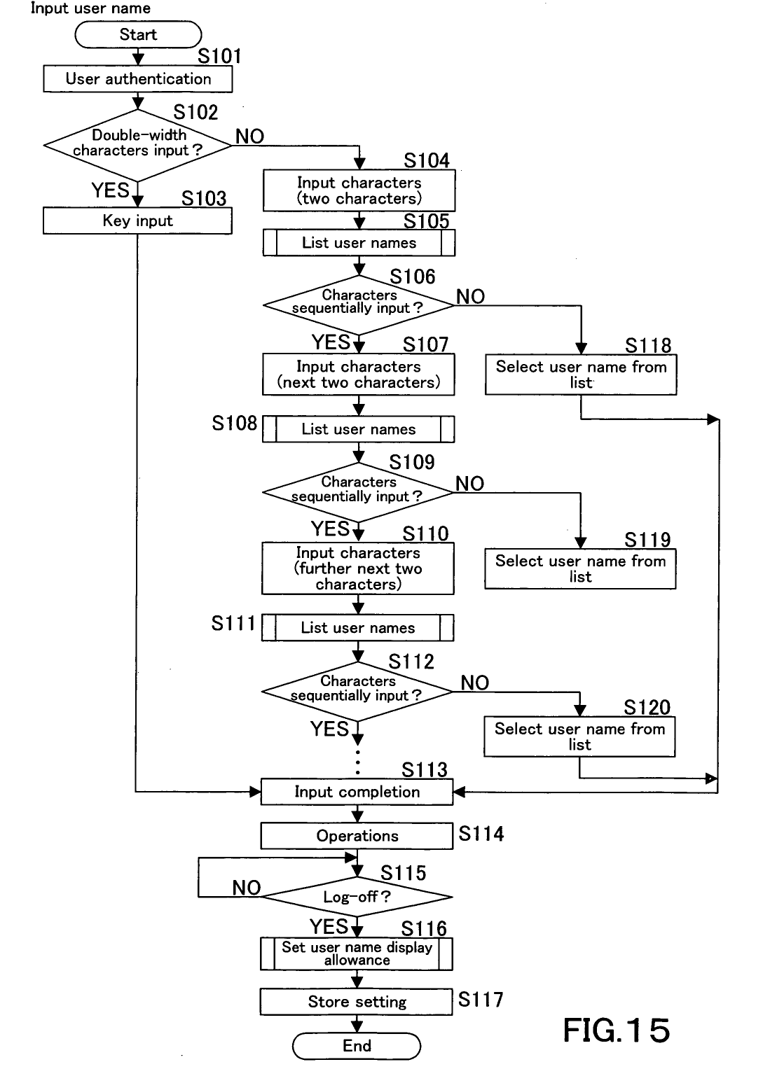

Subsequently, a description will be given of a processing routine executed by the CPU 8 in the MFP 1 in inputting the user name at the time of the user authentication illustrated in FIGS. 4 to 9 in reference to a flowchart illustrated in FIG. 15. Here, a step is abbreviated by “S” in the following description and drawings.

Referring to FIG. 15, in S101, the CPU 8 determines a user authentication mode, and then, displays the user name input screen illustrated in FIG. 4. Thereafter, it is judged in S102 as to whether or not all characters of the user name is input, that is, as to whether or not the character input key A is depressed on the screen illustrated in FIG. 4. If all characters are input (i.e., the judgment in S102 is YES), the key input processing of inputting all characters is performed in S103, and thereafter, the control routine proceeds to S113.

In contrast, if all characters are not input, that is, “the selection input key” B is depressed on the screen illustrated in FIG. 4 (i.e., the judgment in S102 is NO), the input screen illustrated in FIG. 5 is displayed in S104, and thereafter, a character input receiving processing is performed.

In S105, the registration keys E of the user names which correspond to the input two characters without setting the display-off are extracted from the storage unit 17, and then, are listed. Here, the registration key E of the user name whose display-off is set is excluded from the contents to be listed.

Thereafter, it is judged in S106 as to whether or not characters are sequentially input. This is judged on, for example, a lapse of time. If the characters are sequentially input (i.e., the judgment in S106 is YES), the control routine proceeds to S107. In contrast, if the characters are not input (i.e., the judgment in S106 is NO), the selecting operation of a predetermined user name from the list of the user names by the user is accepted in S118, and then, the control routine proceeds to S113.

In S107, the character input receiving processing (next characters) is performed. In S108, the registration keys E of the user names which correspond to the input the characters without setting the display-off are extracted from the storage unit 7, and then, are listed. Also in this case, the registration key E of the user name whose display-off is set is excluded from the contents to be listed.

Thereafter, it is judged in S109 as to whether or not characters are sequentially input. If the characters are sequentially input (i.e., the judgment in S109 is YES), the control routine proceeds to S110. In contrast, if the characters are not sequentially input (i.e., the judgment in S109 is NO), the selecting operation of the predetermined user name from the list of the user names by the user is accepted in S119, and then, the control routine proceeds to S113.

In S110, the character input receiving processing (further next two characters) is performed. In S111, the registration keys E of the user names which correspond to the input the characters without setting the display-off are extracted from the storage unit 7, and then, are listed. Also in this case, the registration key E of the user name whose display-off is set is excluded from the contents to be listed.

Thereafter, it is judged in S112 as to whether or not characters are sequentially input. If the characters are sequentially input (i.e., the judgment in S112 is YES), the character input receiving processing, the listing processing of the predetermined user name and the judging processing of the character input are repeated hereinafter. Upon inputting all of the characters, the control routine proceeds to S113.

If the characters are not sequentially input in S112 (i.e., the judgment in S112 is NO), the selecting operation of the predetermined user name from the list of the user names is accepted in S120, and then, the control routine proceeds to S113.

An input completion processing is performed in S113. In other words, the password input also is accepted, and then, the information is transmitted to the authentication server 3, from which an authentication result is obtained.

When the authentication is established, the CPU 8 allows each of the component parts in the MFP 1 to perform operation designated by the user in S114. And then, it is judged in S115 as to whether or not log-off is performed. If the log-off is performed (i.e., the judgment in S115 is YES), the control routine proceeds to S116. In contrast, if the log-off is not performed (i.e., the judgment in S115 is NO), the control routine returns to S115.

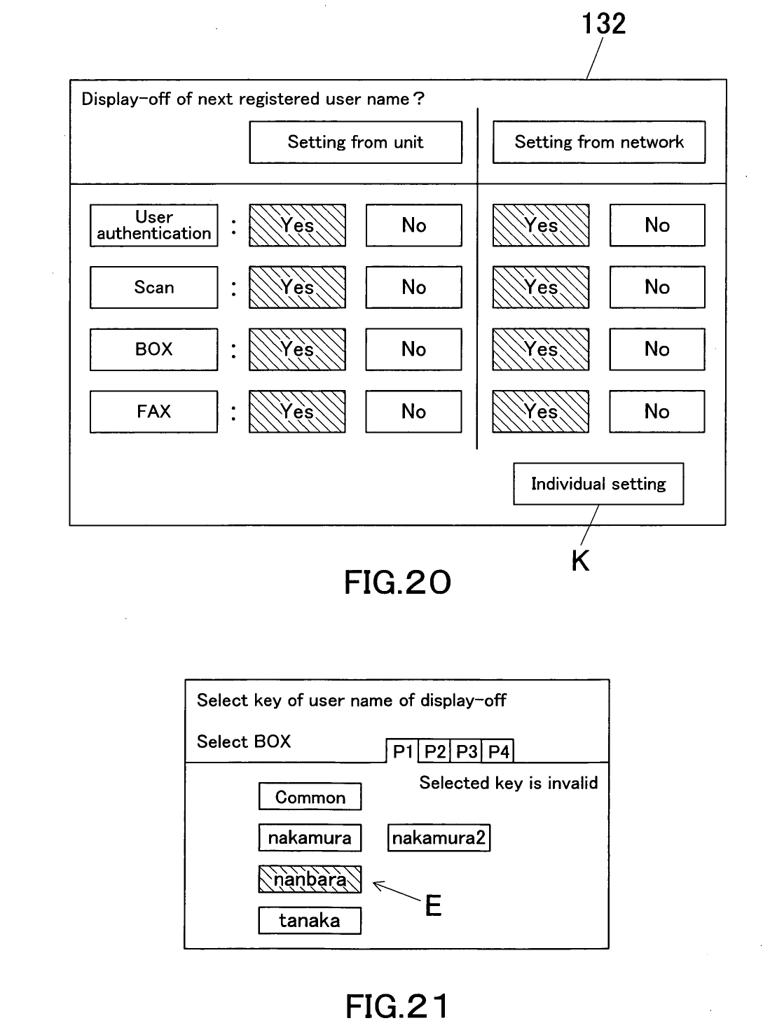

In S116, the user must set the user name display allowance (here, a screen illustrated in FIGS. 20 and 21 are displayed). Thereafter, in S117, the setting is stored in the storage unit 7, and then, the control routine comes to an end. At the time of a next operation of the MFP 1, another setting is reflected.

In this manner, in the case where the user receives the authentication, the candidates of the user names are automatically extracted upon inputting of a part of the user name, so that the extracted candidates of the user names are displayed on the display 132, thus alleviating a cumbersome operation for inputting the user name.

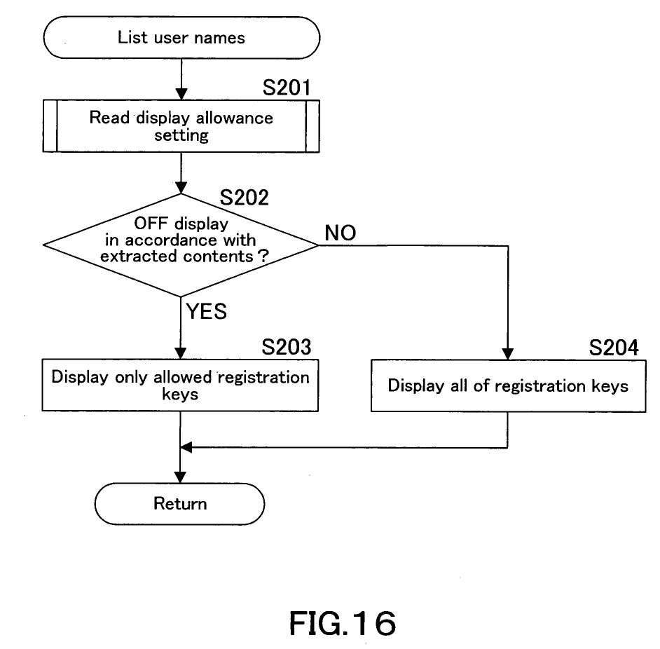

Subsequently, FIG. 16 is a flowchart illustrating a sub-routine of the processing of listing the user names illustrated in FIG. 15 (S105, S108 and S111).

Referring to FIG. 16, the registered contents of the display allowance setting are read from the storage unit 7 in S201. Thereafter, it is judged in S202 as to whether or not there is a user who sets the display-off in accordance with the extracted registered contents. If there is a user who sets the display-off (i.e., the judgment in S202 is YES), only the registration keys of the user names of users who allow the display or do not set the display-off are displayed in S203, and then, the control routine is returned. In contrast, if there is no user who sets the display-off (i.e., the judgment in S202 is NO), all of the registration keys are displayed in S204, and then, the control routine is returned.

In this manner, the user who intends not to allow his or her user name to be displayed can set the display-off. Consequently, it is possible to meet the demand of the user who intends not to allow his or her personal information to be caught by other users during the input operation.

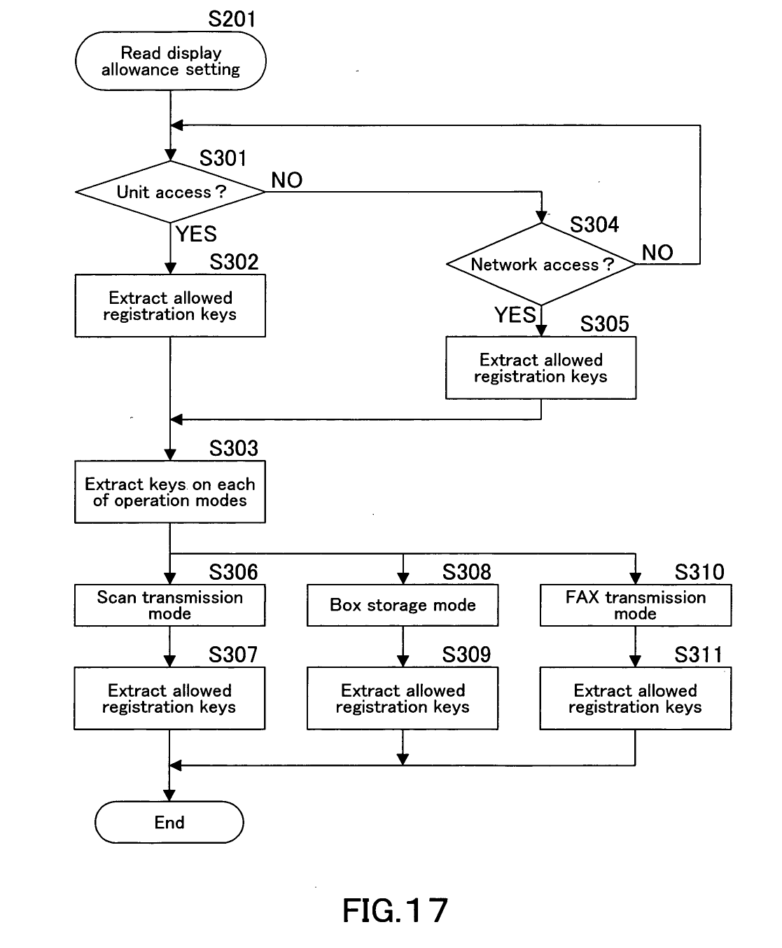

FIG. 17 is a flowchart illustrating a-sub-routine of the processing of reading the display allowance setting when the registration keys of the user names are displayed for designating the transmission destination of the image data or the destination of the storage box of the image data during the use of the function of the MFP 1.

Referring to FIG. 17, it is judged in S301 as to whether or not the access method is the unit access. If the access method is the unit access (i.e., the judgment in S301 is YES), the registration keys of the user names whose display is allowed in the case of the unit access are extracted in S302, and then, the control routine proceeds to S303.

In contrast, if the access method is not the unit access (i.e., the judgment in S301 is NO), it is judged in S304 as to whether or not the access method is the network access. If the access method is the network access (i.e., the judgment in S304 is YES), the registration keys of the user names whose display is allowed in the case of the network access are extracted in S305, and then, the control routine proceeds to S303. To the contrary, if the access method is not the network access (i.e., the judgment in S304 is NO), the control routine is returned to S301.

In S303, a key extracting processing is performed on each of operation modes. Specifically, when the user names need be listed on a scan transmission mode in S306, the registration keys of the user names whose display is allowed on the scan transmission mode are further extracted in S307 from the registration keys extracted in S302 and S305, and then, the reading processing comes to an end.

Otherwise, when the user names need be listed on a box storage mode in S308, the registration keys of the user names whose display is allowed on the box storage mode are further extracted in S309 from the registration keys extracted in S302 and S305, and then, the reading processing comes to an end.

Alternatively, when the user names need be listed on a facsimile transmission mode in S310, the registration keys of the user names whose display is allowed on the facsimile transmission mode are further extracted in S311 from the registration keys extracted in S302 and S305, and then, the reading processing comes to an end.

The registration keys of the user names extracted in S307, S309 and S311 are listed on the display 132 on the operation panel 13. The registration key of the user name whose display-off is set cannot be listed.

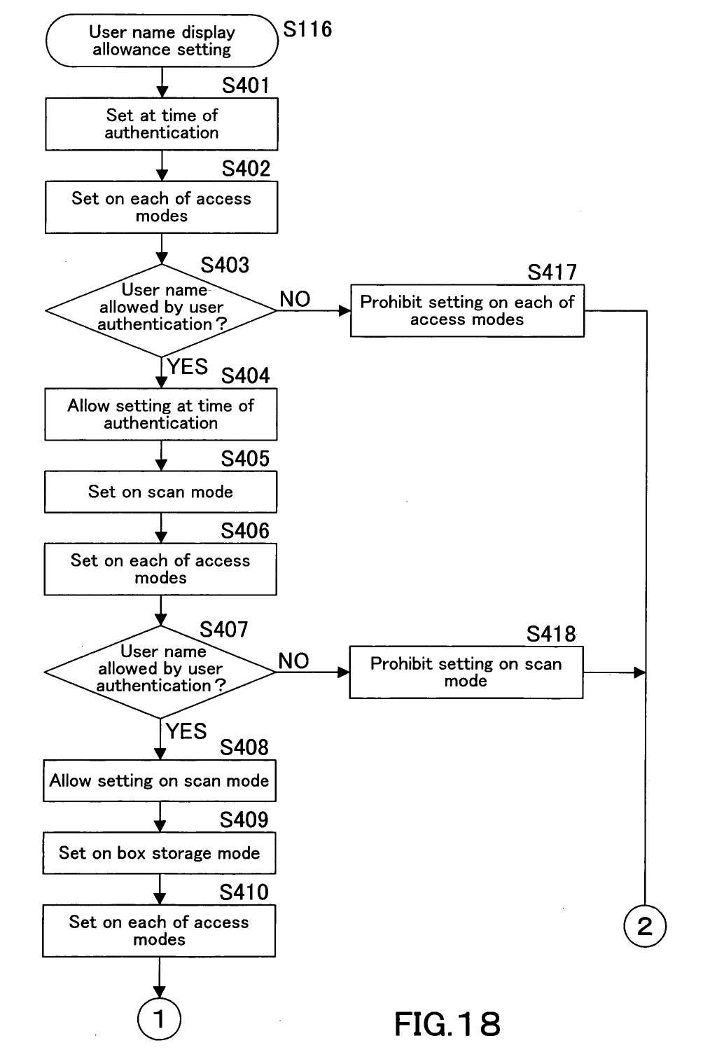

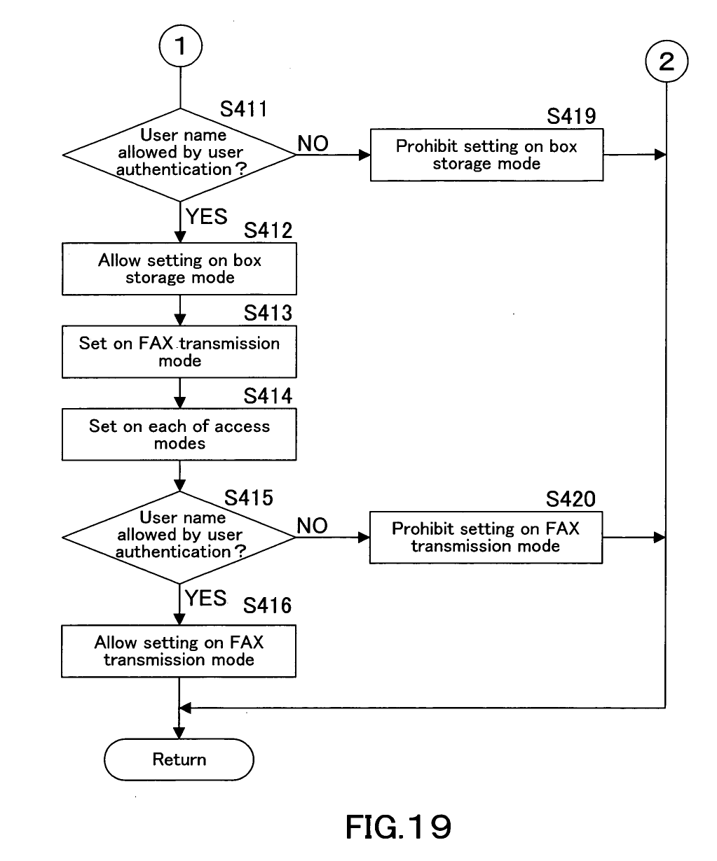

A description will be given below of the contents of the user name display allowance setting processing illustrated in S116 of FIG. 15 in reference to flowcharts illustrated in FIGS. 18 and 19 and diagrams illustrated in FIGS. 20 and 21.

FIG. 20 illustrates the setting input screen displayed on the display 132 on the operation panel 13. This screen is displayed at the time of the log-off of the MFP 1, as described above. Since next display allowance setting is requested during the log-off, the user can perform setting or confirmation every time the MFP 1 is used.

The user sets the display allowance on the display screen. The display allowance can be set each of the authentication time, the scan transmission mode, the box storage mode and the facsimile transmission mode, and further, it can be individually set on the access modes of the unit access and the network access.

First, a “YES” button is depressed on the screen illustrated in FIG. 20 in the case of the setting of the display-off, and then, an “individual setting” button K is depressed. Then, the user names are listed, as illustrated in FIG. 21. Here, when the registration key E of the user name whose display-off is intended to be set is selected, the display-off of the user name is set. Incidentally, FIG. 21 illustrates a setting example on the box storage mode.

Referring to FIGS. 18 and 19, the user name display allowance setting input at the time of the authentication input is accepted in S401, and then, the setting input is individually accepted on each of the access modes in accordance with the unit access or the network access in S402.

It is judged in S403 as to whether or not the user name whose display allowance is to be set is identical to the user name of the user who is allowed by the user authentication, in other words, as to whether or not the user who performs the setting operation performs the setting of his or her user name. If the user name is identical to the user name allowed by the user authentication (i.e., the judgment in S403 is YES), the display allowance setting at the time of the authentication is allowed in S404, to be registered in the storage unit 7, and then, the control routine proceeds to S405. If the user name is not identical to the user name allowed by the user authentication (i.e., the judgment in S403 is NO), the individual setting on each of the access modes is prohibited in S417, and-then, the control routine comes to an end as it is.

The user name display allowance setting input on the scan mode is accepted in S405, and further, the individual setting input on each of the access modes is accepted in S406. Thereafter, it is judged in S407 as to whether or not the user name whose display allowance is to be set is identical to the user name of the user who is allowed by the user authentication.

If the user name is identical to the user name allowed by the user authentication (i.e., the judgment in S407 is YES), the display allowance setting on the scan mode is allowed in S408, to be registered in the storage unit 7, and then, the control routine proceeds to S409. If the user name is not identical to the user name allowed by the user authentication (i.e., the judgment in S407 is NO), the display allowance setting on the scan mode is prohibited in S418, and then, the control routine comes to an end as it is.

The user name display allowance setting input on the box storage mode is accepted in S409, and further, the individual setting input on each of the access modes is accepted in S410. Thereafter, it is judged in S411 as to whether or not the user name whose display allowance is to be set is identical to the user name of the user who is allowed by the user authentication.

If the user name is identical to the user name allowed by the user authentication (i.e., the judgment in S411 is YES), the display allowance setting on the box storage mode is allowed in S412, to be registered in the storage unit 7, and then, the control routine proceeds to S413. If the user name is not identical to the user name allowed by the user authentication (i.e., the judgment in S411 is NO), the display allowance setting on the box storage mode is prohibited in S419, and then, the control routine comes to an end as it is.

The user name display allowance setting input on the facsimile transmission mode is accepted in S413, and further, the individual setting input on each of the access modes is accepted in S414. Thereafter, it is judged in S415 as to whether or not the user name whose display allowance is to be set is identical to the user name of the user who is allowed by the user authentication.

If the user name is identical to the user name allowed by the user authentication (i.e., the judgment in S415 is YES), the display allowance setting on the facsimile transmission mode is allowed in S416, to be registered in the storage unit 7, and then, the control routine is returned. If the user name is not identical to the user name allowed by the user authentication (i.e., the judgment in S415 is NO), the display allowance setting on the facsimile transmission mode is prohibited in S420, and then, the control routine comes to an end as it is.

In this manner, in the present preferred embodiment, it is judged as to whether or not the user name whose display allowance is to be set is identical to the user name of the user who is allowed by the user authentication. As a result, if the user name is identical to the user name allowed by the user authentication, the setting is allowed: in contrast, if the user name is not identical, the setting is prohibited. In the case where the setting is prohibited, the prohibition of the setting is displayed on the screen. For example, when the user having the user name “nakamura” designates the other user name “nanbara”, as illustrated in FIG. 21, a message of “the selected key is invalid” is displayed.

Although the preferred embodiment according to the invention has been described above, the invention is not limited to the above-described embodiment. Although the family name of the user such as “nakamura” has been used as the user name, a first name, an identification code, an alphabet or a numeral, for example, may be used as the user name.

Alternatively, although the above-described embodiment has been exemplified by the case where the user name display allowance is set in the MFP 1, the display allowance may be set per character sequence to be retrieved in the case where the user name or a character sequence to be retrieved other than the user name is retrieved and displayed in a personal computer or the like, and further, in the case where candidates of the corresponding character sequences to be retrieved are listed upon inputting of at least one character of the character sequence to be retrieved.

Otherwise, although the authentication server has been installed outside of the MFP 1, an authentication unit may be provided inside of the MFP 1.

Or, although the display allowance has been set on the operation panel 13 of the MFP 1 in the present preferred embodiment, the MFP 1 may be accessed from an outside host via the network, and thus, a display allowance setting screen may be displayed on the host when its session is cut, and then, the display allowance may be set.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

What is claimed is:

1. A display control device comprising:
an extractor for extracting candidates of a character sequence to be retrieved when at least a part of the character sequence to be retrieved is input;
a display controller for displaying, on a display, the candidates of the character sequence to be retrieved extracted by the extractor; and
a setter capable of setting display allowance according to the character sequence to be retrieved;
wherein the display controller excluding the character sequence to be retrieved, which has been set not to be displayed by the setter, from information to be displayed.

2. A display control device comprising:
an extractor for extracting candidates of user names when at least a part of a user name is input in order to get authentication in using an image forming apparatus;
a display controller for displaying, on a display, the candidates of the user names extracted by the extractor; and
a setter capable of setting display allowance according to the user name;
wherein the display controller excluding the user name, which has been set not to be displayed by the setter, from information to be displayed.

3. A display control device comprising:
a setter capable of setting display allowance according to a user name when a predetermined user name is selected from user names displayed on a display, and then, the function of an image forming apparatus is used; and
a display controller for controlling as to whether or not each of the user names is displayed on the display based on contents set by the setter.

4. The display control device according to claim 2, wherein the setter can differently set the display allowance with respect to one and the same user name in accordance with modes of an access to the image forming apparatus by a user.

5. The display control device according to claim 3, wherein the setter can differently set the display allowance with respect to one and the same user name in accordance with modes of an access to the image forming apparatus by a user.

6. The display control device according to claim 3, wherein the setter can differently set the display allowance with respect to one and the same user name in accordance with the function of the image forming apparatus.

7. The display control device according to claim 2, wherein the setter compares a user name of a user who can be allowed to use the image forming apparatus by user authentication with a user name whose display allowance is to be set, thus allowing the setting in the case where both of the user names are identical to each other.

8. The display control device according to claim 3, wherein the setter compares a user name of a user who can be allowed to use the image forming apparatus by user authentication with a user name whose display allowance is to be set, thus allowing the setting in the case where both of the user names are identical to each other.

9. The display control device according to claim 2, wherein the display controller displays, on the display, a display screen for setting next display allowance when a user logs off the image forming apparatus.

10. The display control device according to claim 3, wherein the display controller displays, on the display, a display screen for setting next display allowance when a user logs off the image forming apparatus.

11. An image forming apparatus comprising:
an extractor for extracting candidates of a character sequence to be retrieved when at least a part of the character sequence to be retrieved is input;
a display controller for displaying, on a display, the candidates of the character sequence to be retrieved extracted by the extractor; and
a setter capable of setting display allowance according to the character sequence to be retrieved;
wherein the display controller excluding the character sequence to be retrieved, which has been set not to be displayed by the setter, from information to be displayed.

12. An image forming apparatus comprising:
an extractor for extracting candidates of user names when at least a part of a user name is input in order to get authentication in using an image forming apparatus;
a display controller for displaying, on a display, the candidates of the user names extracted by the extractor; and
a setter capable of setting display allowance according to the user name;
wherein the display controller excluding the user name, which has been set not to be displayed by the setter, from information to be displayed.

13. An image forming apparatus comprising:
a setter capable of setting display allowance according to a user name when a predetermined user name is selected from user names displayed on a display, and then, the function of an image forming apparatus is used; and
a display controller for controlling as to whether or not each of the user names is displayed on the display based on contents set by the setter.

14. A display control method comprising the steps of:
extracting candidates of a character sequence to be retrieved when at least a part of the character sequence to be retrieved is input;
controllably displaying, on a display, the candidates of the character sequence to be retrieved extracted in the extracting step; and
setting display allowance according to the character sequence to be retrieved;
wherein the character sequence to be retrieved, which has been set not to be displayed in the display allowance setting step, being excluded from information to be displayed in the controllably displaying step.

15. A display control method comprising the steps of:
extracting candidates of user names when at least a part of a user name is input in order to get authentication in using an image forming apparatus;
controllably displaying, on a display, the candidates of the user names extracted in the extracting step; and
setting display allowance according to the user name;
wherein the user name, which has been set not to be displayed in the display allowance setting step, being excluded from information to be displayed in the controllably displaying step.

16. A display control method comprising the steps of:
setting display allowance according to a user name when a predetermined user name is selected from user names displayed on a display, and then, the function of an image forming apparatus is used; and
controlling as to whether or not each of the user names is displayed on the display based on contents set in the display allowance setting step.

17. The display control method according to claim 15, wherein the display allowance with respect to one and the same user name can be differently set in accordance with modes of an access to the image forming apparatus by a user in the display allowance setting step.

18. The display control method according to claim 16, wherein the display allowance with respect to one and the same user name can be differently set in accordance with modes of an access to the image forming apparatus by a user in the display allowance setting step.

19. The display control method according to claim 16, wherein the display allowance with respect to one and the same user name can be differently set in accordance with the function of the image forming apparatus in the display allowance setting step.

20. The display control method according to claim 15, wherein in the display allowance setting step, a user name of a user who can be allowed to use the image forming apparatus by user authentication is compared with a user name whose display allowance is to be set, so that the setting is allowed in the case where both of the user names are identical to each other.

21. The display control method according to claim 16, wherein in the display allowance setting step, a user name of a user who can be allowed to use the image forming apparatus by user authentication is compared with a user name whose display allowance is to be set, so that the setting is allowed in the case where both of the user names are identical to each other.

22. The display control method according to claim 15, wherein a display screen for setting next display allowance is displayed on the display in the display controlling step when a user logs off the image forming apparatus.

23. The display control method according to claim 16, wherein a display screen for setting next display allowance is displayed on the display in the display controlling step when a user logs off the image forming apparatus.

24. The display control method according to claim 14 being implemented in an image forming apparatus.

25. The display control method according to claim 15 being implemented in an image forming apparatus.

26. The display control method according to claim 16 being implemented in an image forming apparatus.
